(19) United States
(12) Patent Application Publication
(10) Pub. No.: US 2016/0301466 A1
(43) Pub. Date: Oct. 13, 2016

(54) Methods and Systems for Communicating Via Multiple Sub-Channels Using a Beamforming Network

(71) Applicant: GoNet Systems, Ltd., Tel Aviv (IL)

(72) Inventors: Roy Kinamon, Tel Aviv (IL); Oz Liv, Tel Aviv (IL); Gal Zuckerman, Holon (IL)

(21) Appl. No.: 14/684,958

(22) Filed: Apr. 13, 2015

(51) Int. Cl. H04B 7/26; H04L 27/26; H04W 72/04; H04W 16/28; H04L 5/00

(52) U.S. Cl. CPC H04B 7/2628; H04W 16/28; H04L 5/0007; H04W 72/0446; H04L 27/2628

(57) ABSTRACT

Systems and methods for: (i) communicating via multiple sub-channels using a beamforming network, (ii) transmitting via multiple sub-channels simultaneously using a beamforming network, (iii) transmitting via multiple sub-channels into multiple directions using a beamforming network, and (iv) processing a first wireless transmission arriving concurrently with a second wireless transmission.

### TECHNICAL FIELD

The present application relates to the field of wireless communication. More specifically, it relates to wireless communication systems and methods in a device that includes or supports a beamforming network.

### BACKGROUND

A beamforming network may be provided in a wireless communication system and may be operated in a sending and/or receiving mode, or both, depending on its configuration and requirements. Therefore, such sending and/or receiving capability is generally comprehended in the present disclosure unless indicated otherwise or unless the context limits the subject to one of the two modes in a given instance.

A beamforming network can define (whether by generating or sensing) a beam, e.g., a directional energy beam such as an electromagnetic field beam. The beam may be narrower or broader in its angular extent, and can have one or more lobes or energy peaks as a function of angular direction. Beams can be created by operation of designed phased arrays or multi-antenna systems whereby the plurality of array elements or individual antennas in the system act through superposition to generate (or sense) a beam as needed. Electronic or physical beam steering can be performed to direct the beams as needed. A beamforming network is therefore capable of directing and/or receiving wireless beams into and/or from multiple directions in space, thereby achieving high transmission and/or reception gains operative to improve transmission and/or reception range and/or capacity of wireless channels.

A wireless communication channel may include several sub-channels, each typically covering a different span of frequencies within the wireless channel. Therefore, the present systems have both spatial and frequency sensitivity, which can be optimized by the design and operation of the systems.

It is desirable to affect efficient, fast and error free wireless communication in wireless communication systems, but prior art systems remain prone to deficiencies in these regards.

### SUMMARY

The present systems and methods may be applied to wireless communication systems. An embodiment is directed to a method for transmitting via multiple sub-channels simultaneously using a beamforming network, comprising determining a first plurality of symbols to be conveyed wirelessly to a first wireless-device via a first sub channel belonging to a wireless channel, and a second plurality of symbols to be conveyed wirelessly to a second wireless-device via a second sub channel belonging to said wireless channel; identifying, out of a plurality of beam-ports belonging to a beamforming network, a first beam-port associated with a first set of directions spanning said first wireless-device, and a second beam-port associated with a second set of directions spanning said second wireless-device; and feeding said first beam-port with a first signal conveying said first plurality of symbols via said first sub-channel, and said second beam-port with a second signal conveying said second plurality of symbols via said second sub-channel, such that a first beam conveying the first plurality of symbols is created by the beamforming network toward the first wireless-device, and a second beam conveying the second plurality of symbols is created by the beamforming network toward the second wireless-device.

Another embodiment is directed to a system operative to transmit via multiple sub-channels into multiple directions using a beamforming network, comprising a beamforming network; and a data interface; wherein the system is operative to: (i) extract, from a stream of data received by the system via said data interface: a first and a second plurality of symbols, an identity of a first and a second wireless device associated respectively with said first and second plurality of symbols, and an identity of a first and a second sub-channel belonging to a wireless channel, via which said first and a second plurality of symbols are to be conveyed to said first and a second wireless device respectively, and (ii) feed a first beam-port belonging to said beamforming network with a first signal conveying said first plurality of symbols via said first sub-channel, and a second beam-port belonging to said beamforming network with a second signal conveying said second plurality of symbols via said second sub-channel, such that a first beam conveying said first plurality of symbols is created by the beamforming network toward said first wireless device, and a second beam conveying said second plurality of symbols is created by the beamforming network toward said second wireless device.

Yet another embodiment is directed to a method for processing a first wireless transmission arriving concurrently with a second wireless transmission, comprising receiving via a plurality of beam ports belonging to a beamforming network, respectively, a plurality of signals associated with at least a first and a second orthogonal-frequency-division-multiple-access (OFDMA) wireless transmission arriving concurrently at said beamforming network; performing, per each of said plurality of signals, a fast Fourier transform (FFT), such that a plurality of FFT results are obtained respectively, each FFT result comprising (i) a first information about a first unique set of sub-carriers belonging to said first OFDMA wireless transmission, and (ii) a second information about a second unique set of sub-carriers belonging to said second OFDMA wireless transmission; and identifying, using said first information, one beam port out of said plurality of beam ports as having a strongest occurrence of said first unique set of sub-carriers belonging to said first OFDMA wireless transmission, thereby concluding that said first OFDMA wireless transmission has arrived at said beamforming network primarily via a first direction belonging to a first set of directions associated with said one beam port.

### IN THE DRAWINGS

For a fuller understanding of the nature and advantages of the present concepts, reference is made to the following detailed description of preferred embodiments and in connection with the accompanying drawings, in which:

FIG. 1A illustrates one embodiment of a beamforming network and at least two wireless devices;

FIG. 1B illustrates one embodiment of a first plurality of symbols;

FIG. 1C illustrates one embodiment of a second plurality of symbols;

FIG. 2A illustrates one embodiment of a wireless channel comprising at least two sub channels;

FIG. 2B illustrates one embodiment of a first signal;

FIG. 2C illustrates one embodiment of a second signal;

FIG. 3 illustrates one embodiment of the beamforming network generating at least two beams, each beam covering at least one wireless device;

FIG. 4A illustrates one embodiment of the first signal comprising a first plurality of sub-carriers;

FIG. 4B illustrates one embodiment of the second signal comprising a second plurality of sub-carriers;

FIG. 5A illustrates one embodiment of a base-station connected to a remote radio-head via a data link;

FIG. 5B illustrates one embodiment of a stream of data comprising the first plurality of symbols and the second plurality of symbols, each plurality of symbols is used to generate an associated signal using an inverse-fast-Fourier-transform (IFFT);

FIG. 6 illustrates one embodiment of a method for communicating via multiple sub-channels using a beamforming network;

FIG. 7A illustrates one embodiment of a wireless channel comprising at least two sub channels;

FIG. 7B illustrates one embodiment of a first and a second signal;

FIG. 8 illustrates one embodiment of the beamforming network generating at least two beams, each beam covering at least one wireless device;

FIG. 9 illustrates one embodiment of a first plurality of symbols and a second plurality of symbols, each plurality of symbols is used to generate an associated signal by applying a code-division-multiple-access (CDMA) code;

FIG. 10A illustrates one embodiment of a beam forming network receiving two wireless transmissions arriving concurrently;

FIG, 10B illustrates one embodiment of a decoder;

FIG, 10C illustrates one embodiment of a detector;

FIG. 11A illustrates one embodiment of a first wireless transmission comprising a first unique set of sub-carriers;

FIG. 11B illustrates one embodiment of a second wireless transmission comprising a second unique set of sub-carriers;

FIG. 11C illustrates one embodiment of a first fast Fourier transform (FFT) result;

FIG. 11D illustrates one embodiment of a second FFT result; and

FIG. 12 illustrates one embodiment of a method for processing a first wireless transmission arriving concurrently with a second wireless transmission.

### DETAILED DESCRIPTION

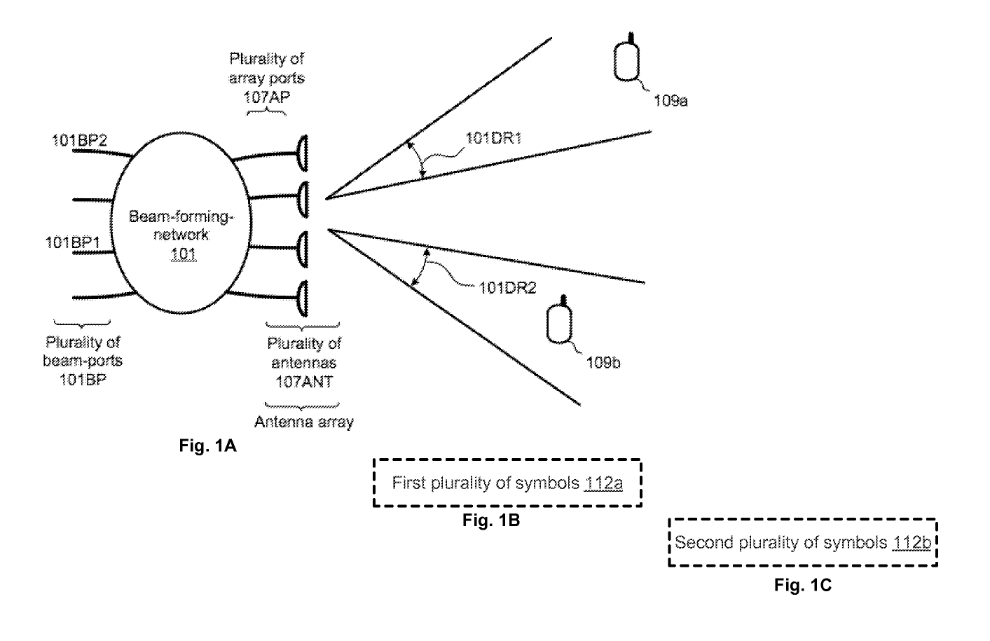

FIG. 1A illustrates an embodiment of a beamforming network and at least two wireless devices. Beamforming network 101 comprises a plurality of beam-ports 101BP and a plurality of array ports 107AP connecting the beamforming network to a plurality of antennas 107ANT. A first beam-port 101BP1 is associated with a first set of directions 101DR1 spanning a first wireless device 109a. A second beam-port 101BP2 is associated with a second set of directions 101DR2 spanning a second wireless device 109b.

FIG. 1B illustrates an exemplary first plurality of symbols. In an aspect, the first plurality of symbols 112a include communication symbols describing data to be conveyed wirelessly to the first wireless device 109a. In another aspect, a first plurality of symbols 112a is a plurality of digital bits associated with data to be conveyed wirelessly. In still another aspect, each symbol included in the first plurality of symbols 112a represents a cluster of bits having a length selected from a group consisting of (i) one bit, (ii) two bits, (iii) three bits, (iv) 4 bits, (v) 5 bits, (vi) 6 bits, (vii) 7 bits, and (viii) 8 bits. In an aspect, a first plurality of symbols 112a is operative to provide data for the modulation of a communication signal in conjunction with a certain modulation type selected from a group consisting of (i) BPSK, (ii) QPSK, (iii) 8QAM, (iv) 16QAM, (v) 32QAM, (vi) 64QAM, (vii) 128QAM, and (viii) 256QAM. Those skilled in the art will understand that the present exemplary embodiments may be extended to other methods of communication without loss of generality. Therefore, where an example or illustrative feature of the present systems and methods is provided it is not intended that this be exhaustive of all of the applications or examples in which the present concepts can be applied, including to regimes of operation that may be devised or discovered by those skilled in the art in the present subject matter but that to which these techniques can be applied as well.

FIG. 1C illustrates an exemplary second plurality of symbols 112b describing data to be conveyed wirelessly to the second wireless device 109b.

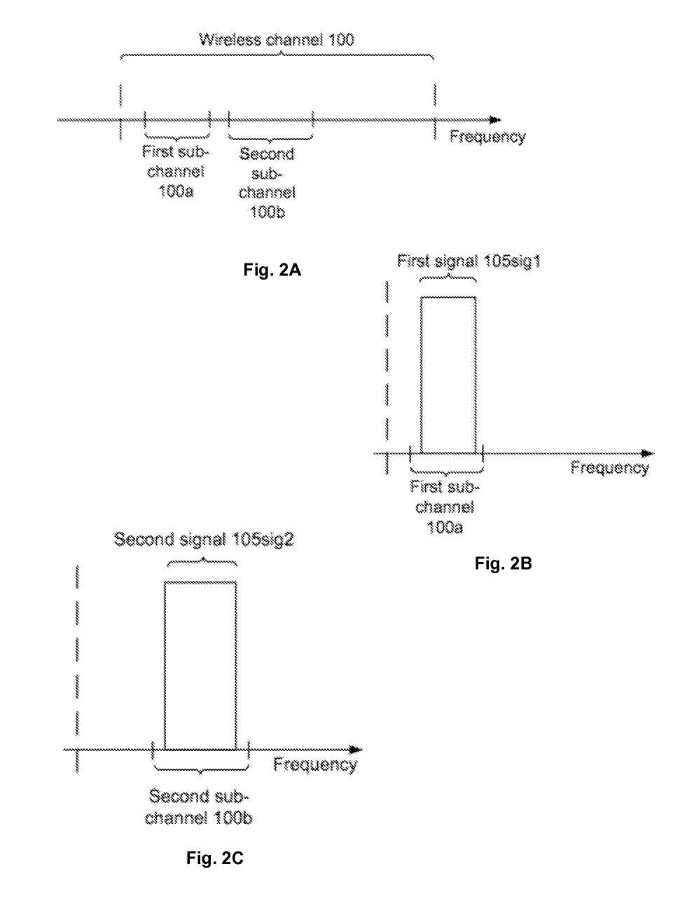

FIG. 2A illustrates an embodiment of a wireless channel comprising at least two sub channels. In one embodiment, wireless channel 100 spans a frequency range (i.e. having a bandwidth) of between 1 MHz and 1 GHz. In one embodiment, wireless channel 100 is located in a frequency band selected from a group consisting of (i) VHF, (ii) UHF, (iii) SHF, and (iv) ISM. In one embodiment, wireless channel 100 is located in a frequency band associated with a communication standard selected from a group consisting of (i) WiMAX, and (ii) LTE. In one embodiment, first sub channel 100a is located inside wireless channel 100 and occupies a unique frequency range. In one embodiment, second sub channel 100b is located inside wireless channel 100 and occupies a unique frequency range, such that the first sub channel 100a and the second sub channel 100b occupy different frequencies. It is noted that although each of the first sub channel 100a and the second sub channel 100b is depicted as being a continuous block of frequencies, each of the first sub channel 100a and the second sub channel 100b may also comprise non-continuous blocks of frequencies within wireless channel 100, as is often the case with sub channels associated with LTE and WiMAX communication standards. In one embodiment, wireless channel 100 is selected from a group consisting of (i) 3.5 MHz WiMAX channel, (ii) 5 MHz WiMAX channel, (iii) 7 MHz WiMAX channel, (iv) 10 MHz WiMAX channel, and (v) 20 MHz WiMAX channel. In one embodiment, wireless channel 100 is selected from a group consisting of (i) 1.4 MHz LTE channel, (ii) 3 MHz LTE channel, (iii) 5 MHz LTE channel, (iv) 10 MHz LTE channel, (v) 15 MHz LTE channel, and (vi) 20 MHz LTE channel. In one embodiment, wireless channel 100 is selected from a group consisting of (i) 250 MHz millimeter-wave channel, (ii) 500 MHz millimeter-wave channel, and (iii) 1 GHz millimeter-wave channel.

FIG. 2B illustrates one embodiment of a first signal. First signal 105sig1 is constructed using the first plurality of symbols 112a, such that first signal 105sig1 is modulated by the first plurality of symbols 112a.

FIG. 2C illustrates one embodiment of a second signal. Second signal 105sig2 is constructed using the second plurality of symbols 112b, such that second signal 105sig2 is modulated by the second plurality of symbols 112b.

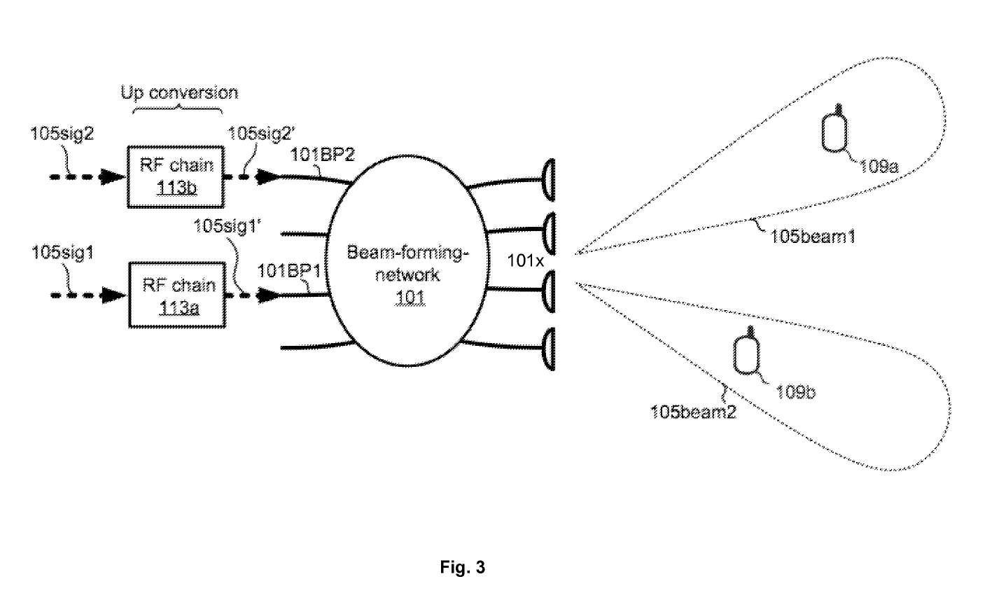

FIG. 3 illustrates an embodiment of a beamforming network 101 generating at least two beams 105beam1, 105beam2, each beam covering at least one wireless device 109a, 109b. Those skilled in the art will appreciate that beams 105beam1, 105beam2 can be formed by a plurality of antennas or array elements 101x, which can be physically or electronically manipulated, phased, etc. so as to form and steer the desired beams (or multiple lobes of one beam). Also, those skilled in the art will appreciate that generating and sending out the stated beams can equivalently be applied to sensing and receiving energy from beams formed by another transmitter other than beamforming network 101.

The first signal 105sig1 is fed directly into a first beam port 101BP1 of beamforming network 101, or alternatively the first signal 105sig1 is fed into the first beam port 101BP1 of beamforming network 101 via RF chain 113a that creates an up-converted version 105sig1′ of the first signal. First signal 105sig1 may be a digital signal, and up-converted version 105sig1′ may be an analog signal. RF chain 113a may comprise a digital-to-analog converter which is not shown. As a result if the above, a first beam 105beam1 is created by the beamforming network 101 toward wireless device 109a, such that the first beam 105beam1 conveys the first signal 105sig1 associated with the first plurality of symbols 112a to the first wireless device 109a. The second signal 105sig2 is fed directly into the second beam port 101BP2 of beamforming network 101, or alternatively the second signal 105sig2 is fed into the second beam port 101BP2 of beamforming network 101 via RF chain 113b that creates an up-converted version 105sig2′ of the second signal. Second signal 105sig2 may be a digital signal, and up-converted version 105sig2′ may be an analog signal. RF chain 113b may comprise a digital-to-analog converter which is not shown. As a result if the above, a second beam 105beam2 is created by the beamforming network 101 toward wireless device 109b, such that the second beam 105beam2 conveys the second signal 105sig2 associated with the second plurality of symbols 112b to the second wireless device 109b. The first beam port 101BP1 is the one selected to be fed by the first signal 105sig1 conveying the first plurality of symbols 112a, because the first beam-port 101BP1 is associated with the first set of directions 101DR1 spanning the first wireless device 109a, to which the first plurality of symbols 112a is intended. The second beam port 101BP2 is the one selected to be fed by the second signal 105sig2 conveying the second plurality of symbols 112b, because the second beam-port 101BP2 is associated with the second set of directions 101DR2 spanning the second wireless device 109b, to which the second plurality of symbols 112b is intended. In an aspect, wireless device 109a moves to a new location that is not covered by the first set of directions 101DR1 associated with the first beam port 101BP1, but which happens to be covered by another set of direction associated with another one of the beam ports, thereby triggering a process in which the first signal 105sig1 is fed into said another one of the beam ports, resulting in creation of another beam covering said new location.

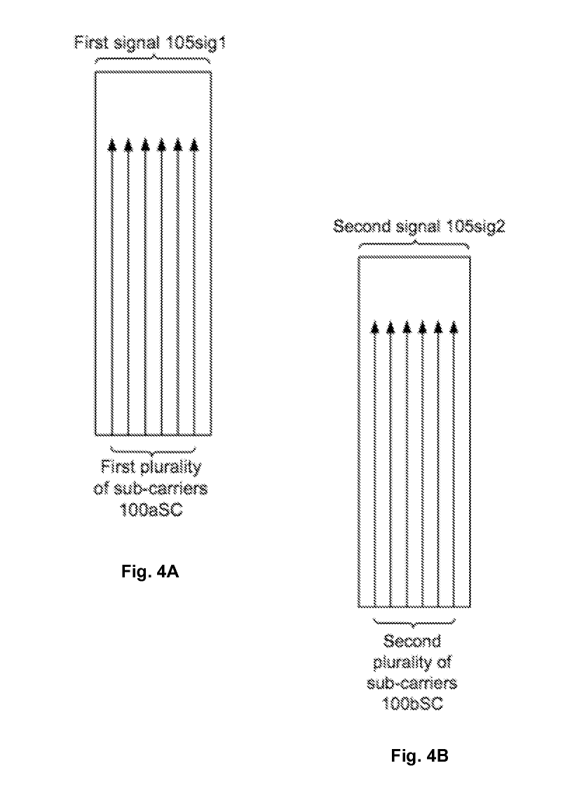

FIG. 4A illustrates an embodiment of the first signal comprising a first plurality of sub-carriers. First signal 105sig1 may include a first plurality of subcarriers 100aSC that may conform to standards such as OFDMA. In an aspect, each carrier of the first plurality of subcarriers 100aSC is modulated by a single symbol of the first plurality of symbols 112a; such a modulation may be achieved using IFFT.

FIG. 4B illustrates an embodiment of the second signal comprising a second plurality of sub-carriers. Second signal 105sig2 may include a second plurality of subcarriers 100bSC that may conform to standards such as OFDMA. In one embodiment, each carrier of the second plurality of subcarriers 100bSC is modulated by a single symbol of the second plurality of symbols 112b.

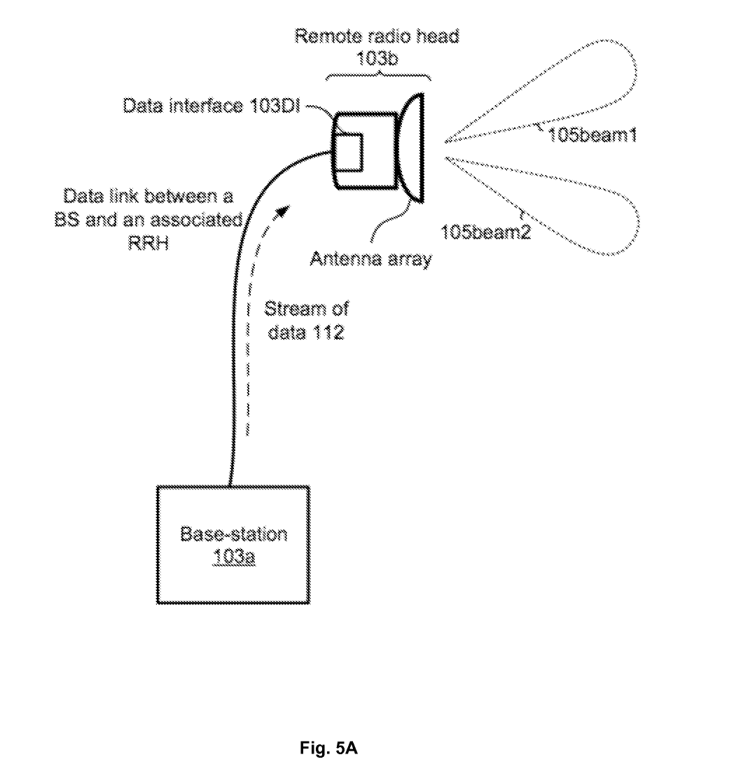

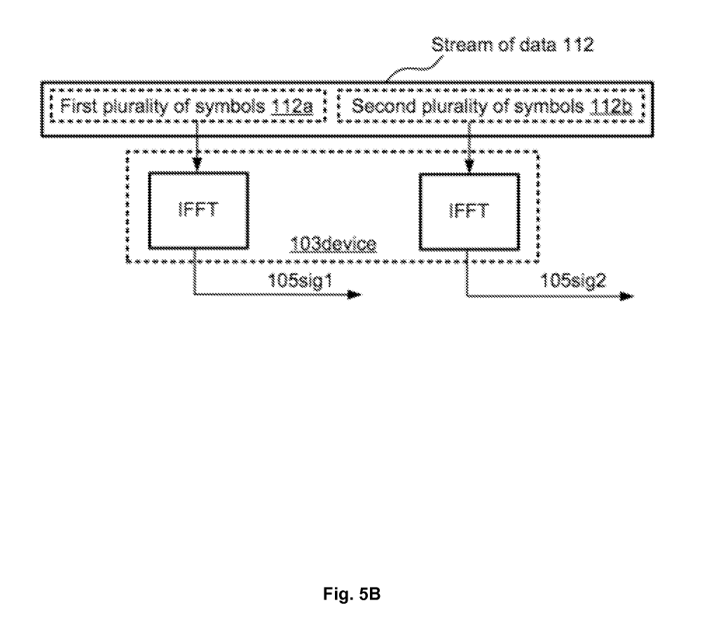

FIG. 5A illustrates an embodiment of a base-station (BS) connected to a remote radio-head (RRH) via a data link. BS 103a is connected to RRH 103b via a data link and data interface 103DI operative to transport a stream of data 112 over a coaxial cable or optical fiber, optionally conforming to standards such as open base station architecture initiative (OBSAI) and common public radio interface (CPRI).

FIG. 5B illustrates an embodiment of the stream of data comprising the first plurality of symbols and the second plurality of symbols, each plurality of symbols is used to generate an associated signal using an inverse-fast-Fourier-transform (IFFT). The stream of data 112 comprises the first plurality of symbols 112a and the second plurality of symbols 112b. An IFFT is used to generate the first signal 105sig1 from the first plurality of symbols 112a. An IFFT is used to generate the second signal 105sig2 from the second plurality of symbols 112b. The IFFT is performed by device 103device, which may be a general purpose processor, a central processing unit (CPU), a digital signal processor (DSP), a field programmable gate array (FPGA), an application specific integrated circuit (ASIC), or any device capable of performing calculations associated with the IFFT.

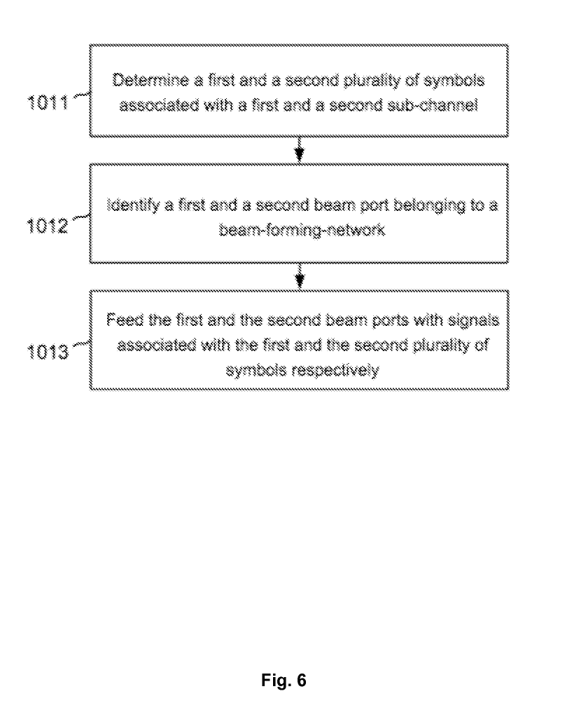

FIG. 6 illustrates an embodiment of a method for communicating via multiple sub-channels using a beamforming network. In step 1011: determining a first plurality of symbols 112a to be conveyed wirelessly to a first wireless-device 109a via a first sub channel 100a belonging to a wireless channel 100, and a second plurality of symbols 112b to be conveyed wirelessly to a second wireless-device 109b via a second sub channel 100b belonging to said wireless channel 100. In step 1012: identifying, out of a plurality of beam-ports 101 BP belonging to a beamforming network 101, a first beam-port 101BP1 associated with a first set of directions 101DR1 spanning said first wireless-device 109a, and a second beam-port 101BP2 associated with a second set of directions 101DR2 spanning said second wireless-device 109b. In step 1013: feeding said first beam-port 101BP1 with a first signal 105sig1 conveying said first plurality of symbols 112a via said first sub-channel 100a, and said second beam-port 101BP2 with a second signal 105sig2 conveying said second plurality of symbols 112b via said second sub-channel 100b, such that a first beam 105beam1 conveying the first plurality of symbols 112a is created by the beamforming network 101 toward the first wireless-device 109a, and a second beam 105beam2 conveying the second plurality of symbols 112a is created by the beamforming network toward the second wireless-device 109b.

In one embodiment, said first beam 105beam1 and second beam 105beam2 are created simultaneously.

In one embodiment, said first sub-channel 100a spans different frequencies than said second sub-channel 100b, thereby facilitating said simultaneous creation of said first beam 105beam1 and second beam 105beam2.

In one embodiment, said first signal 105sig1 and second signal 105sig2 at least partially conform to a standard selected from a group consisting of: (i) WiMAX, and (ii) LTE.

In one embodiment, said first signal 105sig1 and second signal 105sig2 together constitute at least a portion of an orthogonal frequency-division multiple access (OFDMA) transmission.

In one embodiment, said first signal 105sig1 uses a first plurality of sub-carriers 100aSC different in frequency than a second plurality of sub-carriers 100bSC used by said second signal 105sig2.

In one embodiment, said portion is a portion of a frequency spectrum associated with said wireless channel 100 conveying said OFDMA transmission, and said portion comprises a frequency spectrum associated with said first sub-channel 100a and said second sub-channel 100b.

In one embodiment, said portion is at least a single time-slot out of a plurality of time-slots associated with said OFDMA transmission.

In one embodiment, said beamforming network 101 is selected from a group consisting of: (i) a butler matrix, (ii) a rotman lens, (iii) a blass matrix, and (iv) any passive beamforming network comprising beam-ports and array-ports connected to antennas.

One embodiment comprises: synthesizing said first signal 105sig1 by at least performing an inverse fast Fourier transform (IFFT) on said first plurality of symbols 112a, thereby resulting in said first signal 105sig1 comprising a first plurality of sub-carriers 100aSC, and synthesizing said second signal 105sig2 by at least performing an inverse fast Fourier transform (IFFT) on said second plurality of symbols 112b, thereby resulting in said second signal 105sig2 comprising a second plurality of sub-carriers 100bSC.

One embodiment comprises: extracting said first plurality of symbols 112a and said second plurality of symbols 112b from a stream of data 112 conforming to a standard selected from a group consisting of: (i) open base station architecture initiative (OBSAI), and (ii) common public radio interface (CPRI), wherein said extraction achieves said determination of said first plurality of symbols 112a and second plurality of symbols 112b.

In one embodiment, said beamforming network 101 is connected via a plurality of array-ports 107AP to a plurality of antennas 107ANT arranged as an antenna array, together operative to increase an effective isotropic radiated power (EIRP) associated with said first beam 105beam1 and second beam 105beam2, thereby increasing system gain.

In one embodiment, said feeding of said first beam-port 101 BP1 with said first signal 105sig1 comprises feeding said first beam-port 101 BP1 with a first up-converted version 105sig1′ of said first signal 105sig1 using a first radio-frequency chain 113a, and said feeding of said second beam-port 101 BP2 with said second signal 105sig2 comprises feeding said second beam-port 101 BP2 with a second up-converted version 105sig2′ of said second signal 105sig2 using a second radio-frequency chain 113b.

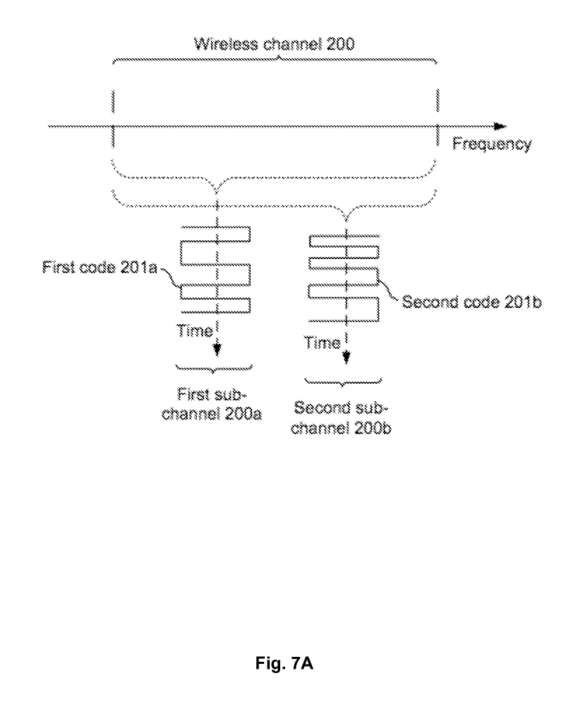

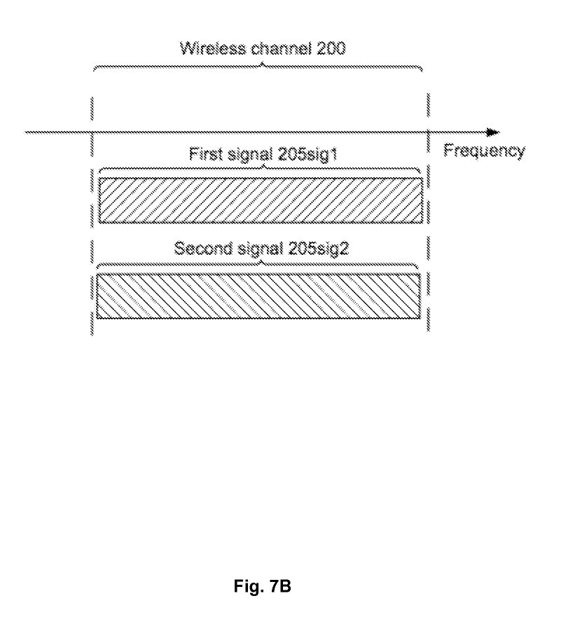

FIG. 7A illustrates one embodiment of a wireless channel comprising at least two sub channels. Wireless channel 200 is spanned by two orthogonal sub-channels: a first sub-channel 200a and a second sub-channel 200b, both sub-channels spreading over the entire spectrum of wireless channel 200. First sub-channel 200a is associated with a first code 201a, which is a CDMA code, and second sub-channel 200b is associated with a second code 201b, which is orthogonal to first code 201a.

FIG. 7B illustrates one embodiment of a first and a second signal. First signal 205sig1 is created by applying a first code 201a, which is a CDMA code, on the first plurality of symbols 112a, and second signal 205sig2 is created by applying a second code 201b, which is orthogonal to first code 201 a, on the second plurality of symbols 112b. It can be said that “the first signal 205sig1 conveys the first plurality of symbols 112a via the first sub-channel 200a”, because the first CDMA code 201a, which is associated with the first sub-channel 200a, was applied on the first plurality of symbols 112a. Similarly, it can be said that “the second signal 205sig2 conveys the second plurality of symbols 112b via the second sub-channel 200b”, because the second CDMA code 201b, which is associated with the second sub-channel 200b, was applied on the second plurality of symbols 112b.

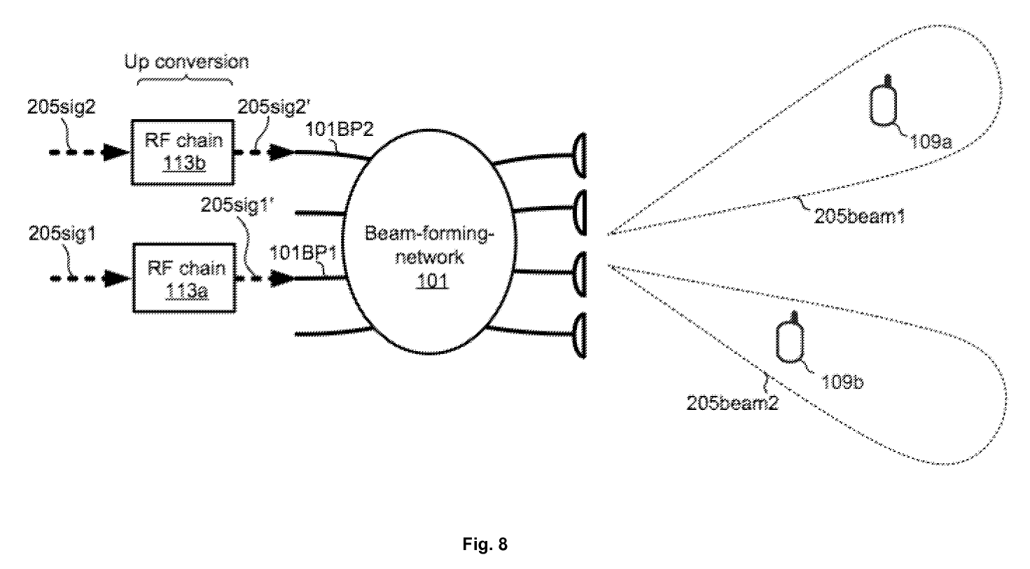

FIG. 8 illustrates one embodiment of the beamforming network 101 generating at least two beams 205beam1, 205beam2, each beam covering at least one wireless device 109a, 109b. A first signal 205sig1 is fed directly into the first beam port 101 BP1 of beamforming network 101, or alternatively the first signal 205sig1 is fed into the first beam port 101BP1 of beamforming network 101 via RF chain 113a that creates an up-converted version 205sig1′ of the first signal. As a result if the above, a first beam 205beam1 is created by the beamforming network 101 toward wireless device 109a, such that the first beam 205beam1 conveys the first signal 205sig1 associated with the first plurality of symbols 112a to the first wireless device 109a. The second signal 205sig2 is fed directly into the second beam port 101 BP2 of beamforming network 101, or alternatively the second signal 205sig2 is fed into the second beam port 101 BP2 of beamforming network 101 via RF chain 113b that creates an up-converted version 205sig2′ of the second signal. As a result if the above, a second beam 205beam2 is created by the beamforming network 101 toward wireless device 109b, such that the second beam 205beam2 conveys the second signal 205sig2 associated with the second plurality of symbols 112b to the second wireless device 109b. The first beam port 101BP1 is the one selected to be fed by the first signal 205sig1 conveying the first plurality of symbols 112a, because the first beam-port 101BP1 is associated with the first set of directions 101DR1 spanning the first wireless device 109a, to which the first plurality of symbols 112a is intended. The second beam port 101 BP2 is the one selected to be fed by the second signal 205sig2 conveying the second plurality of symbols 112b, because the second beam-port 101 BP2 is associated with the second set of directions 101DR2 spanning the second wireless device 109b, to which the second plurality of symbols 112b is intended.

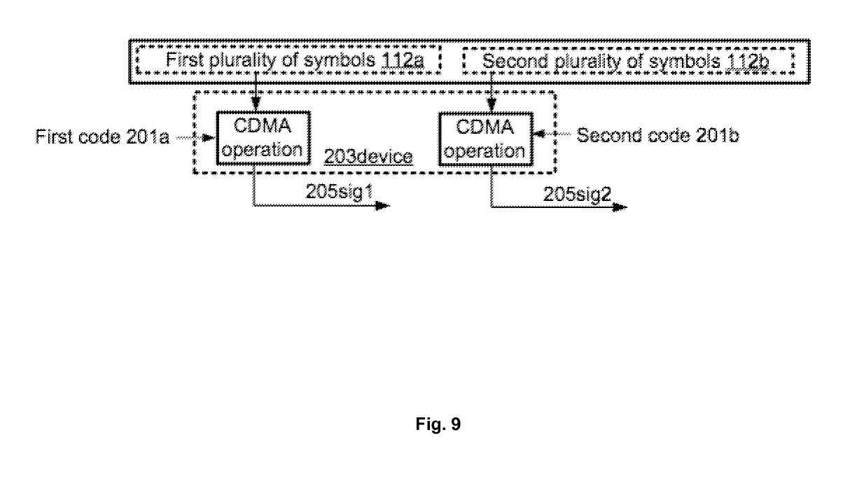

FIG. 9 illustrates one embodiment of a first plurality of symbols and a second plurality of symbols, each plurality of symbols is used to generate an associated signal by applying a code-division-multiple-access (CDMA) code. A CDMA operation is used to generate the first signal 205sig1 from the first plurality of symbols 112a by applying a first code 201a. A CDMA operation is used to generate the second signal 205sig2 from the second plurality of symbols 112b by applying a second code 201b. The CDMA operation is performed by device 203device, which may be a general purpose processor, a central processing unit (CPU), a digital signal processor (DSP), a field programmable gate array (FPGA), an application specific integrated circuit (ASIC), or any device capable of performing calculations associated with the CDMA operation.

One embodiment for communicating via multiple sub-channels using a beamforming network comprises: determining a first plurality of symbols 112a to be conveyed wirelessly to a first wireless-device 109a via a first sub channel 200a belonging to a wireless channel 200, and a second plurality of symbols 112b to be conveyed wirelessly to a second wireless-device 109b via a second sub channel 200b belonging to said wireless channel 200; identifying, out of a plurality of beam-ports 101BP belonging to a beamforming network 101, a first beam-port 101BP1 associated with a first set of directions 101DR1 spanning said first wireless-device 109a, and a second beam-port 101BP2 associated with a second set of directions 101DR2 spanning said second wireless-device 109b; and feeding said first beam-port 101BP1 with a first signal 205sig1 conveying said first plurality of symbols 112a via said first sub-channel 200a, and said second beam-port 101BP2 with a second signal 205sig2 conveying said second plurality of symbols 112b via said second sub-channel 200b, such that a first beam 205beam1 conveying the first plurality of symbols 112a is created by the beamforming network 101 toward the first wireless-device 109a, and a second beam 205beam2 conveying the second plurality of symbols 112a is created by the beamforming network toward the second wireless-device 109b.

One embodiment further comprises: synthesizing said first signal 205sig1 by at least performing a code-division-multiple-access (CDMA) operation on said first plurality of symbols 112a using a first code 201a; and synthesizing said second signal 205sig2 by at least performing a code-division-multiple-access operation on said second plurality of symbols 112b using a second code 201b that is orthogonal to said first code 201a, thereby resulting in said first signal 205sig1 and said second signal 205sig2 being orthogonal to each other, thereby facilitating said first sub-channel 200a and said second sub-channel 200b within said wireless channel 200.

One embodiment is a system operative to transmit via multiple sub-channels into multiple directions using a beamforming network, comprising: a beamforming network 101; and a data interface 103DI; wherein the system is operative to: (i) extract, from a stream of data 112 received by the system via said data interface 103DI: a first 112a and a second 112b plurality of symbols, an identity of a first 109a and a second 109b wireless device associated respectively with said first and second plurality of symbols, and an identity of a first 100a and a second 100b sub-channel belonging to a wireless channel 100, via which said first and a second plurality of symbols are to be conveyed to said first and a second wireless device respectively, and (ii) feed a first beam-port 101BP1 belonging to said beamforming network 101 with a first signal 105sig1 conveying said first plurality of symbols 112a via said first sub-channel 100a, and a second beam-port 101BP2 belonging to said beamforming network with a second signal 105sig2 conveying said second plurality of symbols 112b via said second sub-channel 100b, such that a first beam 105beam1 conveying said first plurality of symbols 112a is created by the beamforming network 101 toward said first wireless device 109a, and a second beam 105beam2 conveying said second plurality of symbols 112a is created by the beamforming network toward said second wireless device 109b.

In one embodiment, said data interface 103DI and stream of data 112 conform to a standard selected from a group consisting of: (i) open base station architecture initiative (OBSAI), and (ii) common public radio interface (CPRI).

In one embodiment, said system is a remote radio-head 103b (RRH) system.

One embodiment comprises: a base-station 103a connected via said data interface 103DI to said remote-radio-head 103b, and operative to generate said stream of data 112.

One embodiment comprises: a first 113a and a second 113b radio-frequency chain operative to up-convert said first 105sig1 and second 105sig2 signal respectively before said feeding into said first 101 BP1 and second 101 BP2 beam-port respectively.

One embodiment comprises: a device 103device operative to perform at least an inverse fast Fourier transform (IFFT) on said first 112a and second 112b plurality of symbols, thereby generating said first 105sig1 and second 105sig2 signals respectively, comprising a first 100aSC and a second 100bSC plurality of subcarriers respectively.

One embodiment comprises: a plurality of array-ports 107AP and a plurality of antennas 107ANT, wherein said beamforming network 101 is connected via said plurality of array-ports 107AP to said plurality of antennas 107ANT arranged as an antenna array, together operative to increase an effective isotropic radiated power (EIRP) associated with said first beam 105beam1 and second beam 105beam2, thereby increasing system gain.

One embodiment is a system operative to transmit using multiple code-division-multiple-access (CDMA) codes into multiple directions using a beamforming network, comprising: a beamforming network 101; and a device 203device operative to perform at least a CDMA operation; wherein the system is operative to: feed a first beam-port 101BP1 belonging to said beamforming network 101 with a first signal 205sig1 conveying a first plurality of symbols 112a, said first signal 205sig1 generated by said device 203devie by applying a first CDMA code 201a on said first plurality of symbols 112a; and feed a second beam-port 101BP2 belonging to said beamforming network 101 with a second signal 205sig2 conveying a second plurality of symbols 112b, said second signal 205sig2 generated by said device 203device by applying a second CDMA code 201b on said second plurality of symbols 112b, such that a first beam 205beam1 conveying said first plurality of symbols 112a is created by the beamforming network 101 toward a first wireless device 109a, and a second beam 205beam2 conveying said second plurality of symbols 112b is created by the beamforming network 101 toward a second wireless device 109b.

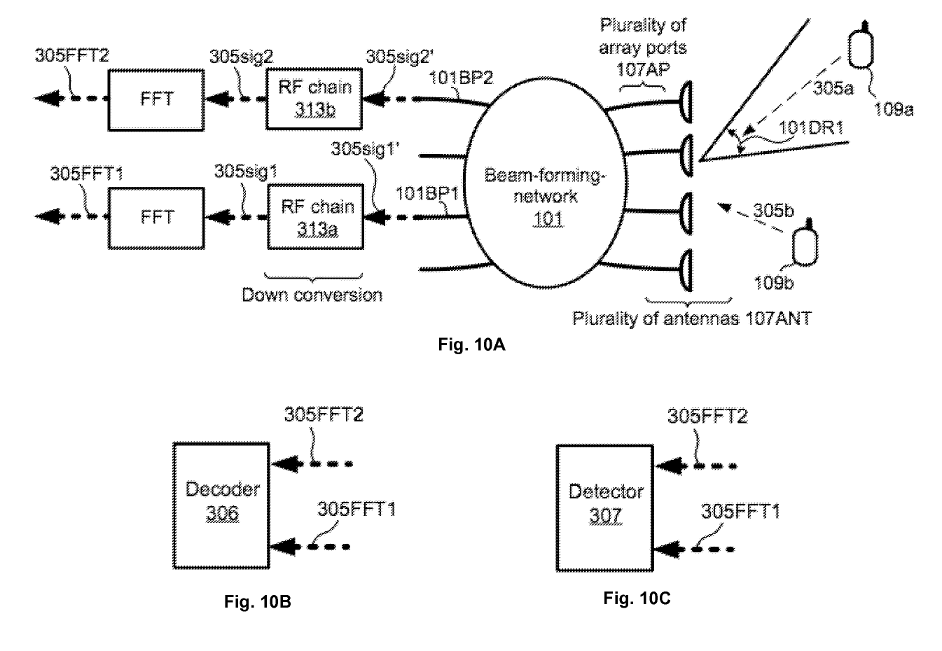

FIG. 10A illustrates an embodiment of a beam forming network 101 receiving two wireless transmissions 305a, 305b arriving concurrently, e.g., from two separate wireless transmitting devices 109a, 109b. First wireless device 109a transmits a first 305a orthogonal-frequency-division-multiple-access (OFDMA) wireless transmission, which arrives via a plurality of antennas 107ANT and a plurality of array ports 107AP at beamforming network 101 concurrently with a second 305b OFDMA wireless transmission transmitted by second wireless device 109b. First 305a OFDMA wireless transmission arrives at beamforming network 101 via a first direction belonging to a first set of directions 101DR1 associated with a first beam port 101BP1, while second 305b OFDMA wireless transmission arrives at beamforming network 101 via a different direction that is outside the first set of directions 101DR1 associated with the first beam port 101BP1. As a result of the difference in directions, a first signal 305sig1, which is received via the first beam port 101BP1, comprises a strong component of first 305a OFDMA wireless transmission, together with a weak component of second 305b OFDMA wireless transmission, while a second signal 305sig2, which is received via a second beam port 101BP2, comprises a weak component of first 305a OFDMA wireless transmission, together with a component of second 305b OFDMA wireless transmission, which may be strong if the second beam port 101BP2 is associated with a set of directions spanning a direction from which second 305b OFDMA wireless transmission arrives at the beamforming network 101.

Detecting a presence of a strong component of first 305a OFDMA wireless transmission in first signal 305sig1, as opposed to a weaker component of first 305a OFDMA wireless transmission in second signal 305sig2, is a good indication that first 305a OFDMA wireless transmission has arrived via a direction that is spanned by the first set of directions 101DR1; in case of such a detection, the first signal 305sig1, rather than the second signal 305sig2, will be used to decode the first 305a OFDMA wireless transmission. The second signal 305sig2 may be use to decode the second 305b OFDMA wireless transmission. The first signal 305sig1 may be a down-converted version of a prior signal 305sig1′, which is an analog signal down-converted by RF chain 313a. RF chain 313a may include an analog-to-digital converter not shown. The second signal 305sig2 may be a down-converted version of a prior signal 305sig2′, which is an analog signal down converted by RF chain 313b. RF chain 313b may include an analog-to-digital converter not shown. Since the first signal 305sig1 has both a strong component of first 305a OFDMA wireless transmission and a weak component of second 305b OFDMA wireless transmission, the different components must be separated before detecting the strength of the components and before decoding the stronger component. Such a separation may be achieved using a fast Fourier transform (FFT), assuming that each of the first 305a and second 305b OFDMA wireless transmission is using a unique frequency allocation (sub-channeling) within a common wireless channel, which is the case with OFDMA transmissions. FFT result 305FFT1 is obtained by performing an FFT operation on the first signal 305sig1, and FFT result 305FFT2 is obtained by performing an FFT operation on the second signal 305sig2. Such a separation may also be achieved by means of code-division operations, which is the case with CDMA transmissions.

FIG. 10B illustrates an exemplary decoder. Decoder 306 is operative to decode first 305a and second 305b OFDMA wireless transmission by receiving as an input the first FFT result 305FFT1 and the second FFT result 305FFT2. Decoder 306 may include a switching mechanism operative to select between FFT result 305FFT1 and FFT result 305FFT2. Decoder 306 may be a processor, a DSP, an FPGA, an ASIC, or any mechanism operative to decode first 305a and second 305b OFDMA wireless transmission.

FIG. 10C illustrates an exemplary detector. Detector 307 is operative to detect first 305a and second 305b OFDMA wireless transmission by receiving as an input the first FFT result 305FFT1 and the second FFT result 305FFT2. Detector 307 may include a switching mechanism operative to select between FFT result 305FFT1 and FFT result 305FFT2. Detector 307 may be a processor, a DSP, an FPGA, an ASIC, or any mechanism operative to detect first 305a and second 305b OFDMA wireless transmission. Detection may refer to the process of determining signal strength, signal power, signal energy, a certain signal characteristic such as transient shape or spectral shape, or detection of any other signal property.

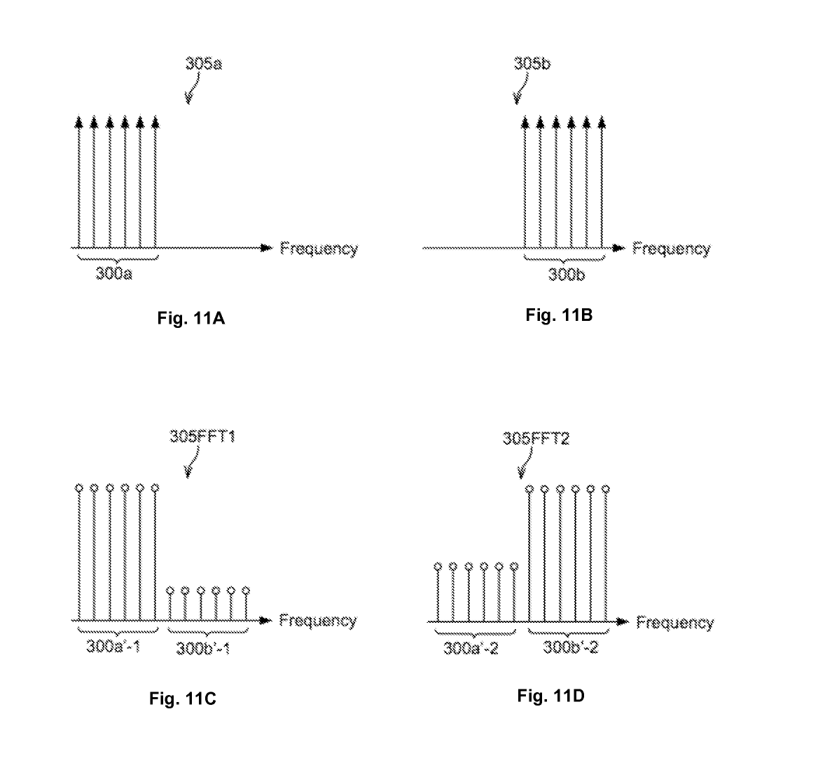

FIG. 11A illustrates an embodiment of a first wireless transmission comprising a first unique set of sub-carriers. First 305a OFDMA wireless transmission may include a first 300a unique set of sub-carriers, occupying frequencies allocated as a first sub-channel of an OFDMA transmission. Sub-carriers may refer to a plurality of carrier signals occupying a certain sub-channel and frequencies, or may refer to a plurality of carrier signals modulated by symbols, together occupying a certain sub-channel and frequencies.

FIG. 11B illustrates an embodiment of a second wireless transmission comprising a second unique set of sub-carriers. Second 305b OFDMA wireless transmission may include a second 300b unique set of sub-carriers, occupying frequencies allocated as a second sub-channel of an OFDMA transmission. Second 300b unique set of sub-carriers are unique in the sense that they are different sub-carriers (i.e. occupying different frequencies) than first 300a unique set of sub-carriers.

FIG. 11C illustrates an embodiment of a first fast Fourier transform (FFT) result. First FFT result 305FFT1 comprises a first information 300a′-1 about the first 300a unique set of sub-carriers belonging to the first 305a OFDMA wireless transmission; this first information 300a′-1 is the strong occurrence of first 305a OFDMA wireless transmission as a component within the first signal 305sig1, as seen via the first beam port 101BP1. First FFT result 305FFT1 also comprises a second information 300b′-1 about the second 300b unique set of sub-carriers belonging to the second 305b OFDMA wireless transmission; this second information 300b′-1 is the weak occurrence of second 305b OFDMA wireless transmission as a component within the first signal 305sig1, as seen via the first beam port 101BP1.

FIG. 11D illustrates an embodiment of a second FFT result. Second FFT result 305FFT2 comprises a first information 300a′-2 about the first 300a unique set of sub-carriers belonging to the first 305a OFDMA wireless transmission; this first information 300a′-2 is the weak occurrence of first 305a OFDMA wireless transmission as a component within the second signal 305sig2, as seen via the second beam port 101 BP2. Second FFT result 305FFT2 also comprises a second information 300b′-2 about the second 300b unique set of sub-carriers belonging to the second 305b OFDMA wireless transmission; this second information 300b′-2 is the strong occurrence of second 305b OFDMA wireless transmission as a component within the second signal 305sig2, as seen via the second beam port 101 BP2.

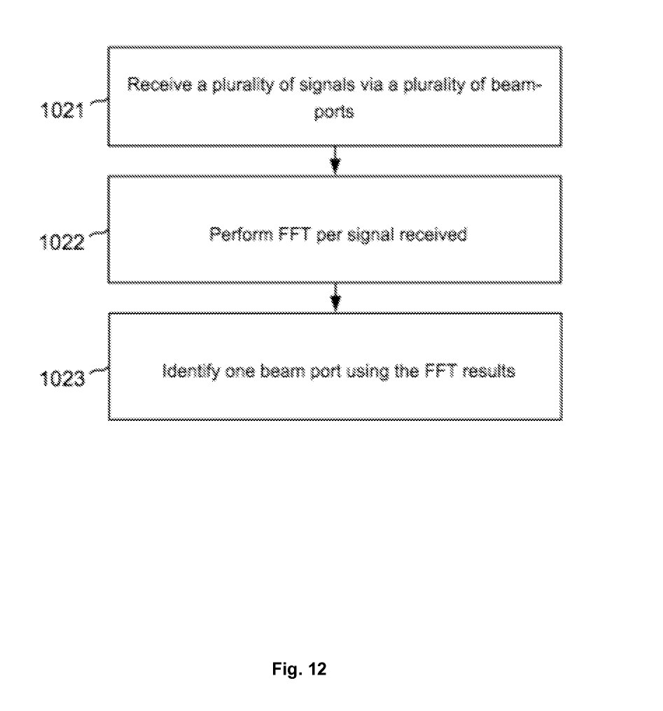

FIG. 12 illustrates an exemplary method for processing a first wireless transmission arriving concurrently with a second wireless transmission. In step 1021: receiving via a plurality of beam ports 101BP1, 101BP2 belonging to a beamforming network 101, respectively, a plurality of signals 305sig1, 305sig2 associated with at least a first 305a and a second 305b orthogonal-frequency-division-multiple-access (OFDMA) wireless transmission arriving concurrently at said beamforming network. In step 1022: performing, per each of said plurality of signals 305sig1, 305sig2, a fast Fourier transform (FFT), such that a plurality of FFT results 305FFT1, 305FFT2 are obtained respectively, each FFT result comprising (i) a first information 300a′ about a first 300a unique set of sub-carriers belonging to said first 305a OFDMA wireless transmission, and (ii) a second information 300b′ about a second 300b unique set of sub-carriers belonging to said second 305b OFDMA wireless transmission. In step 1023: identifying, using said first information 300a′-1, 300a′-2, one beam port 101BP1 out of said plurality of beam ports 101BP1, 101BP2 as having a strongest occurrence of said first 300a unique set of sub-carriers belonging to said first 305a OFDMA wireless transmission, thereby concluding that said first 305a OFDMA wireless transmission has arrived at said beamforming network 101 primarily via a first direction belonging to a first set of directions 101DR1 associated with said one beam port 101BP1. In one embodiment, a strongest occurrence of a unique set of sub-carriers means a strongest occurrence of power level of a unique set of sub-carriers, e.g. 300a′-1 (first occurrence of 300a) has a higher power level than 300a′-2 (second occurrence of 300a), therefore beam port 101BP1 is identified as a beam port to be used for further processing/decoding/bearing finding of first 305a OFDMA wireless transmission. In one embodiment, a strongest occurrence of a unique set of sub-carriers means a strongest occurrence of signal-to-noise ratio (SNR) of a unique set of sub-carriers, e.g. 300a′-1 (first occurrence of 300a) has a higher SNR than 300a′-2 (second occurrence of 300a), therefore beam port 101 BP1 is identified as a beam port to be used for further processing, decoding, or bearing finding of first 305a OFDMA wireless transmission. In one embodiment, a strongest occurrence of a unique set of sub-carriers means a better decoding result of a unique set of sub-carriers, e.g. 300a′-1 (first occurrence of 300a) is decoded to produce a first bit-error-ration (BER) which is higher than a second BER produced by decoding 300a′-2 (second occurrence of 300a).

One embodiment comprises: associating said first 300a unique set of sub-carriers with a fist wireless-device 109a, thereby concluding that said first wireless-device has a bearing spanned by said first set of directions 101DR1, and wherein said first unique set of sub-carriers is associated with a first OFDMA sub-channel 100a.

One embodiment comprises: concluding that said first OFDMA sub-channel 100a was used during a period that was specifically reserved for said fist wireless-device 109a, thereby achieving said association.

One embodiment comprises: decoding a synchronization layer of a communication channel to which said first 305a OFDMA wireless transmission belongs, thereby reaching said conclusion about said reservation. In one embodiment, said communication channel is associated with a communication standard selected from a group consisting of: (i) WiMAX, and (ii) LTE.

In one embodiment, said decoding is done by extracting information from a stream of data conforming to a standard selected from a group consisting of: (i) open base station architecture initiative (OBSAI), and (ii) common public radio interface (CPRI).

One embodiment comprises: recording said conclusion that said first wireless-device 109a has a bearing spanned by said first set of directions 101DR1 associated with said one beam-port 101BP1, thereby facilitating a future decision to transmit to said first wireless-device via said one beam-port.

One embodiment comprises: decoding 306 said first 305a OFDMA wireless transmission using one 305sig1 of said plurality of signals 305sig1, 305sig2 that was received via said one beam port 101BP1 identified.

In this description, numerous specific details are set forth. However, the exemplary disclosed embodiments and aspects of the invention may be practiced without some of these specific details. In other instances, well-known hardware, materials, structures and techniques have not been shown in detail in order not to obscure the understanding of this description. In this description, references to “an embodiment”, “one embodiment” and “one aspect” mean that the feature being referred to may be included in at least one embodiment/case of the invention. Moreover, separate references to “an embodiment”, “one embodiment”, “embodiments” and “one aspect” in this description do not necessarily refer to the same embodiment/case. Illustrated embodiments/cases are not mutually exclusive, unless so stated and except as will be readily apparent to those of ordinary skill in the art. Thus, the invention may include any variety of combinations and/or integrations of the features of the embodiments/cases described herein.

Also, flow diagrams illustrate non-limiting embodiment/case examples of the methods, and block diagrams illustrate non-limiting embodiment/case examples of the devices. Some operations in the flow diagrams may be described with reference to the embodiments/cases illustrated by the block diagrams. However, the methods of the flow diagrams could be performed by embodiments/cases of the invention other than those discussed with reference to the block diagrams, and embodiments/cases discussed with reference to the block diagrams could perform operations different from those discussed with reference to the flow diagrams. Moreover, although the flow diagrams may depict serial operations, certain embodiments/cases could perform certain operations in parallel and/or in different orders from those depicted. Moreover, the use of repeated reference numerals and/or letters in the text and/or drawings is for the purpose of simplicity and clarity and does not in itself dictate a relationship between the various embodiments/cases and/or configurations discussed. Furthermore, methods and mechanisms of the embodiments/cases will sometimes be described in singular form for clarity. However, some embodiments/cases may include multiple iterations of a method or multiple instantiations of a mechanism unless noted otherwise. For example, when a controller or an interface are disclosed in an embodiment/case, the scope of the embodiment/case is intended to also cover the use of multiple controllers or interfaces.

Certain features of the embodiments/cases, which may have been, for clarity, described in the context of separate embodiments/cases, may also be provided in various combinations in a single embodiment/case. Conversely, various features of the embodiments/cases, which may have been, for brevity, described in the context of a single embodiment/case, may also be provided separately or in any suitable sub-combination. The embodiments/cases are not limited in their applications to the details of the order or sequence of steps of operation of methods, or to details of implementation of devices, set in the description, drawings, or examples. In addition, individual blocks illustrated in the figures may be functional in nature and do not necessarily correspond to discrete hardware elements. While the methods disclosed herein have been described and shown with reference to particular steps performed in a particular order, it is understood that these steps may be combined, sub-divided, or reordered to form an equivalent method without departing from the teachings of the embodiments/cases. Unless specifically indicated herein, the order and grouping of the steps is not a limitation of the embodiments/cases. Embodiments/cases described in conjunction with specific examples are presented by way of example, and not limitation. Moreover, it is evident that many alternatives, modifications and variations will be apparent to those skilled in the art. Accordingly, the present invention comprehends all such alternatives, modifications and variations that fall within the spirit and scope of the appended claims and their equivalents.

What is claimed is:

1. A method for transmitting via multiple sub-channels into multiple directions using a beamforming network, comprising:
determining a first plurality of symbols to be conveyed wirelessly to a first wireless-device via a first sub channel belonging to a wireless channel, and a second plurality of symbols to be conveyed wirelessly to a second wireless-device via a second sub channel belonging to said wireless channel;
identifying, out of a plurality of beam-ports belonging to a beamforming network, a first beam-port associated with a first set of directions spanning said first wireless-device, and a second beam-port associated with a second set of directions spanning said second wireless-device; and
feeding said first beam-port with a first signal conveying said first plurality of symbols via said first sub-channel, and said second beam-port with a second signal conveying said second plurality of symbols via said second sub-channel, such that a first beam conveying the first plurality of symbols is created by the beamforming network toward the first wireless-device, and a second beam conveying the second plurality of symbols is created by the beamforming network toward the second wireless-device.

2. The method of claim 1, wherein said first beam and second beam are created simultaneously.

3. The method of claim 2, wherein said first sub-channel spans different frequencies than said second sub-channel, thereby facilitating said simultaneous creation of said first beam and second beam.

4. The method of claim 1, wherein said first signal and second signal at least partially conform to a standard selected from a group consisting of: (i) WiMAX, and (ii) LTE.

5. The method of claim 1, wherein said first signal and second signal together constitute at least a portion of an orthogonal frequency-division multiple access (OFDMA) transmission.

6. The method of claim 5, wherein said first signal uses a first plurality of sub-carriers different in frequency than a second plurality of sub-carriers used by said second signal.

7. The method of claim 5, wherein said portion is a portion of a frequency spectrum associated with said wireless channel conveying said OFDMA transmission, and said portion comprises a frequency spectrum associated with said first sub-channel and said second sub-channel.

8. The method of claim 5, wherein said portion is at least a single time-slot out of a plurality of time-slots associated with said OFDMA transmission.

9. The method of claim 1, wherein said beamforming network is selected from a group consisting of: (i) a butler matrix, (ii) a rotman lens, (iii) a blass matrix, and (iv) any passive beamforming network comprising beam-ports and array-ports connected to antennas.

10. The method of claim 1, further comprising synthesizing said first signal by at least performing an inverse fast Fourier transform (IFFT) on said first plurality of symbols thereby resulting in said first signal comprising a first plurality of sub-carriers; and synthesizing said second signal by at least performing an inverse fast Fourier transform (IFFT) on said second plurality of symbols thereby resulting in said second signal comprising a second plurality of sub-carriers.

11. The method of claim 10, further comprising extracting said first plurality of symbols and said second plurality of symbols from a stream of data conforming to a standard selected from a group consisting of: (i) open base station architecture initiative (OBSAI), and (ii) common public radio interface (CPRI), wherein said extraction achieves said determination of said first plurality of symbols and second plurality of symbols.

12. The method of claim 1, wherein said beamforming network is connected via a plurality of array-ports to a plurality of antennas arranged as an antenna array, together operative to increase an effective isotropic radiated power (EIRP) associated with said first beam and second beam, thereby increasing system gain.

13. The method of claim 1, further comprising synthesizing said first signal by at least performing a code-division-multiple-access (CDMA) operation on said first plurality of symbols using a first code; and synthesizing said second signal by at least performing a code-division-multiple-access operation on said second plurality of symbols using a second code that is orthogonal to said first code, thereby resulting in said first signal and said second signal being orthogonal to each other, thereby facilitating said first sub-channel and said second sub-channel within said wireless channel.

14. A system operative to transmit via multiple sub-channels into multiple directions using a beamforming network, comprising:
a beamforming network; and
a data interface;
wherein the system is operative to:
extract, from a stream of data received by the system via said data interface: a first and a second plurality of symbols, an identity of a first and a second wireless device associated respectively with said first and second plurality of symbols, and an identity of a first and a second sub-channel belonging to a wireless channel, via which said first and a second plurality of symbols are to be conveyed to said first and a second wireless device respectively; and
feed a first beam-port belonging to said beamforming network with a first signal conveying said first plurality of symbols via said first sub-channel, and a second beam-port belonging to said beamforming network with a second signal conveying said second plurality of symbols via said second sub-channel, such that a first beam conveying said first plurality of symbols is created by the beamforming network toward said first wireless device, and a second beam conveying said second plurality of symbols is created by the beamforming network toward said second wireless device.

15. The system of claim 14, wherein said data interface and stream of data conform to a standard selected from a group consisting of: (i) open base station architecture initiative (OBSAI), and (ii) common public radio interface (CPRI).

16. The system of claim 15, wherein said system is a remote radio-head (RRH) system.

17. The system of claim 16, further comprising a base-station connected via said data interface to said remote radio-head, and operative to generate said stream of data.

18. The system of claim 14, further comprising a first and a second radio-frequency chain operative to up-convert said first and second signal respectively before said feeding into said first and second beam-port respectively.

19. The system of claim 14, further comprising a device operative to perform at least an inverse fast Fourier transform (IFFT) on said first and second plurality of symbols, thereby generating said first and second signals respectively, comprising a first and a second plurality of subcarriers respectively.

20. The system of claim 14, further comprising a plurality of array-ports and a plurality of antennas, wherein said beamforming network is connected via said plurality of array-ports to said plurality of antennas arranged as an antenna array, together operative to increase an effective isotropic radiated power (EIRP) associated with said first beam and second beam, thereby increasing system gain.

21. A system operative to transmit using multiple code-division-multiple-access (CDMA) codes into multiple directions using a beamforming network, comprising:
a beamforming network; and
a device operative to perform at least a CDMA operation;
wherein the system is operative to:
feed a first beam-port belonging to said beamforming network with a first signal conveying a first plurality of symbols, said first signal generated by said device by applying a first CDMA code on said first plurality of symbols; and
feed a second beam-port belonging to said beamforming network with a second signal conveying a second plurality of symbols;
said second signal generated by said device by applying a second CDMA code on said second plurality of symbols, such that a first beam conveying said first plurality of symbols is created by the beamforming network toward a first wireless device, and a second beam conveying said second plurality of symbols is created by the beamforming network toward a second wireless device.

22. A method for processing a first wireless transmission arriving concurrently with a second wireless transmission, comprising:
receiving via a plurality of beam ports belonging to a beamforming network, respectively, a plurality of signals associated with at least a first and a second orthogonal-frequency-division-multiple-access (OFDMA) wireless transmission arriving concurrently at said beamforming network;
performing, per each of said plurality of signals, a fast Fourier transform (FFT), such that a plurality of FFT results are obtained respectively, each FFT result comprising (i) a first information about a first unique set of sub-carriers belonging to said first OFDMA wireless transmission, and (ii) a second information about a second unique set of sub-carriers belonging to said second OFDMA wireless transmission; and
identifying, using said first information, one beam port out of said plurality of beam ports as having a strongest occurrence of said first unique set of sub-carriers belonging to said first OFDMA wireless transmission, thereby concluding that said first OFDMA wireless transmission has arrived at said beamforming network primarily via a first direction belonging to a first set of directions associated with said one beam port.

23. The method of claim 22, further comprising associating said first unique set of sub-carriers with a fist wireless-device, thereby concluding that said first wireless-device has a bearing spanned by said first set of directions, and wherein said first unique set of sub-carriers is associated with a first OFDMA sub-channel.

24. The method of claim 23, further comprising concluding that said first OFDMA sub-channel was used during a period that was specifically reserved for said fist wireless-device, thereby achieving said association.

25. The method of claim 24, further comprising decoding a synchronization layer of a communication channel to which said first OFDMA wireless transmission belongs, thereby reaching said conclusion about said reservation.

26. The method of claim 25, wherein said communication channel is associated with a communication standard selected from a group consisting of: (i) WiMAX, and (ii) LTE.

27. The method of claim 25, wherein said decoding is done by extracting information from a stream of data conforming to a standard selected from a group consisting of: (i) open base station architecture initiative (OBSAI), and (ii) common public radio interface (CPRI).

28. The method of claim 23, further comprising: recording said conclusion that said first wireless-device has a bearing spanned by said first set of directions associated with said one beam-port, thereby facilitating a future decision to transmit to said first wireless-device via said one beam-port.

29. The method of claim 22, further comprising decoding said first OFDMA wireless transmission using one of said plurality of signals that was received via said one beam port identified.
